(19) United States
(12) Patent Application Publication
(10) Pub. No.: US 2021/0133889 A1
(43) Pub. Date: May 6, 2021

(54) METHOD FOR IMPROVING THE ENVIRONMENT BY PROVIDING INCENTIVES FOR PURCHASE, LEASE, RE-LEASE, RENTAL, OR SUBSCRIPTION OF ENVIRONMENTALLY FRIENDLY ZERO EMISSION, LOW EMISSION AND BATTERY ELECTRIC VEHICLES

(71) Applicant: Mitchel May, Hewlett, NY (US)

(72) Inventor: Mitchel May, Hewlett, NY (US)

(21) Appl. No.: 16/949,413

(22) Filed: Oct. 28, 2020

Related U.S. Application Data
(60) Provisional application No. 62/927,812, filed on Oct. 30, 2019.

(51) Int. Cl. G06Q 40/08; G06Q 20/12; G06Q 30/06; G06Q 30/00; G06Q 30/02; G06Q 10/10; G06Q 50/26; G06N 20/00

(52) U.S. Cl. CPC G06Q 40/08; G06Q 20/127; G06Q 30/0645; G06Q 30/018; G06N 20/00; G06Q 10/10; G06Q 30/0205; G06Q 50/26; G06Q 30/0208

(57) ABSTRACT

A means and method for improving the environment by presenting an insurance incentive to procure a BEV/ZEV/LEV vehicle. The insurance incentive can be bundled with other incentives to further encourage procurement of environmentally friendly BEV/ZEV/LEV vehicles.

### TITLE OF THE INVENTION

A Method for Improving the Environment by Providing Incentives for Purchase, Lease, Re-Lease, Rental, or Subscription of Environmentally Friendly Zero Emission, Low Emission and Battery Electric Vehicles

### CLAIM FOR PRIORITY

This Non-Provisional US Patent Application claims priority from US Provisional Patent application No. 62/927,812 “A Method for improving the Environment by Providing Incentives for Purchase, Lease, Subscription, or Re-Lease of Environmentally Friendly Zero Emission, Low Emission and Battery Electric Vehicles”.

### CROSS-REFERENCE TO RELATED APPLICATIONS

This application is related to U.S. patent application Ser. No. 14/206,990 entitled “APPARATUSES, METHODS AND SYSTEMS FOR INSURANCE INCENTIVE PROGRAM FOR PROMOTING THE PURCHASE OR LEASE OR RE-LEASE OFA VEHICLE” filed on Mar. 12, 2014, the entirety of which is incorporated herein by reference.

### FIELD OF THE INVENTION

The present invention is directed generally to a method for improving the environment by providing incentives to purchase, lease or re-lease, re-lease or re-lease, rent, or subscribe to Zero Emission, Low Emission and Battery Electric Vehicles.

### BACKGROUND OF THE INVENTION

It is well known that Zero Emission Vehicles (ZEV), Low Emission Vehicles (LEV) and Battery Electric Vehicles (BEV) have a very positive impact on the environment due to the fact that use of these vehicles significantly reduces the amount of greenhouse gases and other pollutants discharged into the environment. In the past, there have been governmental incentives to buy or lease or re-lease these vehicles, usually in the form of tax credits or tax deductions. However, these incentives have been insufficient to entice enough consumers/customers to buy these vehicles in the numbers that would result in significant improvements in air quality and the overall environment.

It is generally agreed that the higher the percentage of LEV, ZEV and/or BEV vehicles on the highway, the better the environmental quality will be. Specifically, LEV, ZEV and/or BEV vehicles improve the environment by:
1. Reducing fossil fuel carbon-based emissions
2. Reducing noise pollution
3. Reducing congestion due to the fact that car-poolers are more inclined to ride in BEV/LEV/ZEV vehicles.
4. Reducing the overall impact of the extended fossil fuel logistics chain, and
5. Reducing the amount of other environmentally dangerous (i.e. non-biodegradable, flammable, etc.) fluids and components, associated with internal combustion engines such as transmission fluid, engine oil, hydraulic fluids, spark plugs, etc.

The present invention discloses a method for improving the environment by providing a series of incentives for consumers/customers to purchase, lease or re-lease, rent, or subscribe to a BEV/ZEV/LEV vehicle. The BEV/ZEV/LEV vehicles may be conventionally driven/operated vehicles, semi-autonomous vehicles, and/or fully autonomous vehicles. These incentives can include, but are not limited to, free or discounted services plans, free or discounted insurance, other insurance products at discounted rates (i.e. bundling), extended warranties, reduced financing rates, discounted battery charging rates for electric vehicles, credits and/or discounts for charging with green energy, and a credit management program to take advantage of governmental credits.

The underlying principle associated with the present invention is that greater use of BEV/LEV/ZEV vehicles leads to an improvement in environmental quality as BEV/LEV/ZEV vehicles replace internal combustion engine vehicles.

One typical problem faced by purchasers, subscribers or lessees of vehicles, in particular those acquiring ZEB, BEV or LEV vehicles, is obtaining insurance for the vehicle at the time of sale, lease, re-lease, rental, or subscription. The buyer must typically complete many forms to obtain the insurance. In addition, many insurance companies have little experience insuring LEV, BEV or ZEV vehicles and would most likely charge higher rates than warranted. These issues may deter the buyer from completing the sale, lease, re-lease, rental, or subscription and delay or negate the environmental benefits that such a purchase or lease, rental, subscription, or re-lease may provide to the environment.

Furthermore, the characteristics of the purchaser, such as the age, sex, marital status, area of residence, vehicle usage, the number of drivers living with the buyer and the make and model of the car purchased are all considered by an insurance provider to determine a rate for an insurance premium for the insurance policy sought. The cost of the insurance policy may be prohibitive, thereby impacting sale, lease, re-lease, rental, or subscription of the environmentally friendly LEV, ZEV, or BEV.

In order to address the problems in obtaining insurance, some automobile retailers have offered to provide basic insurance coverage with the sale, lease, rental, re-lease, rental, or subscription of the automobile. For example, Tesla has recently begun offering insurance as part of the monthly payment. However, the premium for the buyer is still evaluated using all of the characteristics identified above, which may result in insurance premiums which are prohibitive for the party receiving the policy. Furthermore, under such programs, the buyer must still complete many forms in order to receive the insurance and must pay a percentage of the premium in advance in order to complete the sale, lease, rental, re-lease, rental, or subscription of the vehicle in accordance with certain state laws. All the above combine to provide disincentives to acquiring environmentally friendly BEV, ZEV or LEV vehicles.

The environmental incentive described by this application is especially important as tax credits for low emission vehicles have recently been reduced or eliminated altogether.

The transactions contemplated herein may include sales, leases, re-leases, rental, or subscriptions directly from a manufacturer or a dealer or a third party entity.

Throughout this specification, the term “vehicle” or “automobile” shall be construed to mean any type of Zero Emission, Low Emission and Battery Electric Vehicle. The vehicle may be an autonomous, semi-autonomous or conventionally driven and/or operated vehicle. In addition, the term “item” shall be construed to represent any type of environmentally friendly vehicle, bus, truck, limousine, ride sharing or ride hailing entity vehicles (Uber, Lyft, etc), airframe, maritime craft, etc. including any type of Zero Emission, Low Emission and Battery Electric Vehicle as well as hybrid vehicles. In addition, the term “rental” generally refers to any type of short term possession of a vehicle including conventional short term rentals (for example, at an airp ride sharing, ride hailing, pick up/drop off vehicles, etc. Furthermore, “retailer” is construed to mean any entity that engages in providing BEV/ZEV/LEV vehicles to consumers, including, but not limited to dealers, or other entities such as Zipcar, Fair, and Mobiliti. In the interests of conciseness, these vehicles will be referred to as “BEV/ZEV/LEV” vehicles. Also, the terms “driver” and “operator” are used interchangeably in this application. The terms “driver” and “operator” may refer to individuals actually situated within the vehicle or individuals who control the vehicle remotely. Furthermore, while the present invention specifically comprises sales, leases, re-leases, rentals, and subscription of vehicles, it also includes ride hailing, ride sharing, pay per use, and other methods of providing environmentally friendly vehicles into commerce. Finally, the terms “procure” and “obtain” may refer to purchase, lease, re-lease, rentals, or subscription of a vehicle.

### SUMMARY OF THE INVENTION

The present application is directed to particular features of a system and method that improves the environment by providing incentives to purchase, lease, re-lease, rentals, or subscribe to a BEV/ZEV/LEV vehicle by providing insurance as a no-cost, or discounted cost “sticker item” on the vehicle at the time of sale, lease, re-lease, rental, or subscription. In addition, no-cost or low cost insurance may be one aspect of a series of bundled products and incentives that will lead to more environmentally friendly items. While other potentially bundled items are valuable to a potential purchaser or lessee, the overall cost, potential delay and administrative hassle involved with obtaining insurance tends to be the largest disincentive. The present invention eliminates this administrative hassle and when combined with other incentives leads to greater use of BEV/ZEV/LEV vehicles and a concomitant improvement of the environment.

In particular, one aspect of the invention includes a method for providing an environmentally friendly incentive relating to a sale, lease, re-lease, rental, or subscription of a BEV/ZEV/LEV vehicle. In this embodiment, a manufacturer determines a class of items for which insurance is to be provided. The manufacturer further determines a geographic region in which a buyer of one of the class of items must reside to receive the insurance. At the time of a sale, lease, re-lease, rental, or subscription of one of the class of items, the manufacturer pays an insurance premium for an insurance policy on behalf of the buyer as an incentive to procure a vehicle. The insurance policy is transmitted instantly to the buyer's smart phone, tablet, etc. via a mobility partner's network. The geographic area in question can be one in which air quality is of paramount concern, such as the Southern California area or it can be a major/multi-state region of the nation. The cost of the insurance provided to the buyer, lessee, renter or subscriber may be included in whole or partially as part of the monthly or periodic price that the consumer pays.

In a second embodiment of the present invention, a method for providing an environmental incentive relating to a sale, lease, re-lease, rental, or subscription of an environmentally friendly item includes a retailer receiving an indication of a class of items for which insurance is to be provided to a buyer/consumer residing in a geographic region without cost to the buyer. The retailer completes a sale, lease, re-lease, rental, or subscription of one of the class of items to a particular buyer residing in the geographic region and confirms that the buyer resides in the geographic region. The retailer then provides a sales/transaction agreement relating to the sale, lease, re-lease, or subscription of the item to the buyer. The sales agreement includes a confirmation of a provision of an insurance policy covering the item. The insurance policy is transmitted instantly in electronic form to the buyer's smart phone, tablet, etc. via a mobility partner's network. The cost of the insurance provided to the buyer, lessee, renter or subscriber may be included in whole or partially as part of the monthly or periodic price that the consumer pays. While the item in question may be BEV/ZEV/LEV vehicles, the item can also be environmentally friendly devices such as solar panels for providing electricity or heating water or other fluids; fuel cells for providing electricity to buildings, homes, or other structures; wind turbines for generating electricity, etc. In such instances, such devices will be purchased or leased. Manufacturers and dealers or other third parties can offer the insurance incentive and include the costs of such insurance in the sales or lease prices.

According to a third embodiment of the present invention, a method for providing an insurance policy relating to a sale, lease, rental, re-lease, or subscription of an item begins when an insurance affiliate receives an indication of an item sold to a buyer for which insurance is provided by a third party. The affiliate works with the insurer and/or agent to develop non-individualized premiums applicable to a particular class of environmentally friendly BEV/ZEV/LEV vehicles in a specific geographic area. The affiliate develops the non-individualized premium by accessing and analyzing data from the insurers, industry data, government data, engineering statistics, risk data, etc. and furthermore relies on artificial intelligence to develop the premium. The affiliate charges a premium for the insurance policy to the third party, the premium based on a class of the item and a geographic region of the buyer without consideration of further qualifications of the buyer, with the possible exception of the buyer possessing a valid driver's or operator's license and having an acceptable credit rating. The insurance policy is transmitted instantly to the buyer's smart phone, personal digital assistant, tablet, etc. via a mobility partner's network. The cost of the insurance provided to the buyer, lessee, renter or subscriber may be included in whole or partially as part of the monthly or periodic price that the consumer pays.

According to a fourth embodiment of the present invention, a method for determining an insurance premium to be charged to a party providing insurance to a buyer of an item begins when an affiliate receives from a manufacturer an indication of a class of items for which insurance is to be provided to a buyer of one of the class of items. The items can be any environmentally friendly BEV/ZEV/LEV vehicles or other environmentally friendly devices such as solar panels, fuel cells, or wind turbines. The affiliate further receives from the manufacturer an indication of a geographic region in which a buyer must reside to receive the insurance. The geographic area can be of any size, for example, a large area such as a region or a state, a medium sized area such as a national or state park, or a small area such as a city, town, township, or county. Based on this data, the affiliate calculates a premium to be charged for each insurance policy issued to purchasers, or lessees, or subscribers in the geographic area, the premium being based on the class of items and the geographic region, without consideration of further characteristics of the buyer, with the possible exception of the buyer possessing a valid driver's or operator's license and having an acceptable credit rating. The affiliate may use information from a variety of sources in determining the premium including OEM data, third party data, analytics, industry data, insurer data, geographic risk ratings, etc.

According to a fifth embodiment of the present invention, a method of receiving an insurance policy with a sale, lease, re-lease, rental, or subscription of an item begins when a buyer/consumer completes a sale, lease, re-lease, rental, or subscription agreement for either a purchase or a lease or re-lease, rental, or subscription of an item. The buyer then receives a paid insurance policy for the item, the insurance policy being provided based on a class of the item and the geographic location in which the buyer resides. The insurance policy is transmitted instantly to the buyer's smart phone, tablet, personal digital assistant, etc. via a mobility partner's network.

A sixth embodiment of the instant invention involves completion of the BEV/ZEV/LEV vehicle transaction directly between the OEM and the buyer or lessee, renter, or subscriber. Alternatively, any transaction involving environmentally friendly devices such as fuel cells, solar panels, and wind turbines may be effected between OEM's and consumers.

A seventh embodiment of the instant invention involves bundling the vehicle insurance incentive with other incentives that will further encourage the consumer to lease or re-lease, rental, or purchase an environmentally friendly ZEV/BEV/LEV. Among the incentives that could potentially be bundled are the following:
1. Other types of insurance such as discounted rates for umbrella/excess liability coverage, additional risk insurance, homeowners/renters insurance, commercial insurance, life insurance, health insurance, professional liability insurance, etc.
2. Free or discounted vehicle maintenance parts and services.
3. Free or discounted vehicle rental services.
4. A discount or credit for charging the vehicle's battery with green energy.
5. A discount, credit or other incentives for use of energy saving smart home or smart business technology.
6. Battery replacement and rehabilitation or battery recycling.
7. Access to off peak electricity for charging batteries at reduced pricing.

In an eighth embodiment of the present invention, the insurance coverage included with the policy may include coverage for contents/cargo of a vehicle, and damage to or damage caused by a defective charging station. Alternatively, insurance coverage for environmentally friendly stationary items will cover damage to grids and other property from malfunction of the environmentally friendly stationary item.

In a ninth embodiment of the present invention, the environment is improved by eliminating the “dual vehicle” situation faced by many employees. The dual vehicle situation generally involves the use of one vehicle for personal use (including commuting) and one vehicle for company use. For example, an individual works for a company that requires that he or she have a company automobile. The company requires that the vehicle be parked/garaged at a company facility when not in use (evenings, weekends, holidays, etc.). The individual has a personal vehicle which he/she drives to the company facility and then transfers to the company vehicle for work. The individual is not allowed to use the company vehicle for any personal use. The additional commuting trips with a personal vehicle result in a detrimental environmental effect.

Some companies allow the company vehicle to be parked/garaged at the individual's home. However, the prohibition against using a company vehicle for personal use remains widespread.

The present invention solves this dual vehicle dilemma by structuring an insurance incentive that covers both the personal use and corporate use of a vehicle—in other words, a dual use vehicle insurance policy. The positive impact on the environment is furthered by providing additional discounts if the dual use vehicle is a BEV/LEV/ZEV vehicle.

In a tenth embodiment of the present invention, vehicle renters are incentivized to improve the environment by renting a BEV/LEV/ZEV vehicle. Such incentives may take the form discounts, waiving insurance requirements, repeat BEV/LEV/ZEV vehicle rentals at discounted prices, and credits towards purchase of BEV/LEV/ZEV vehicles if the driver/operator enjoys the BEV/LEV/ZEV vehicle experience. The term “rental” includes variations of conventional short term rental scenarios (i.e. renting a vehicle at an airport for business) including various ride sharing, vehicle sharing, ride hailing, pick up/drop off short term possession of a vehicle for a fee, etc.

According to further embodiments of the present invention, the item being purchased, leased, re-leased, rented, or subscribed may be an automobile or vehicle of a particular make and model. The insurance policy may be personal or commercial and cover comprehensive, collision and other types of losses relating to the item and may remain in effect even after the buyer moves from the geographic region. Also, the insurance affiliate may charge the manufacturer a flat rate for each policy issued according to the incentive program.

A further embodiment of the instant invention is that insurance will “travel” with the vehicle. Any driver qualified and licensed to drive will be covered when he or she drives the vehicle. In addition, contents of the vehicle may be covered regardless of who owns the contents.

The instant invention has the additional benefit of furthering public policy by being non-discriminatory in nature because there is no opportunity to discriminate against members of certain social demographics by denying insurance or charging higher rates to members of these certain demographic groups.

### BRIEF DESCRIPTION OF THE DRAWINGS

Further aspects of the instant invention will be more readily appreciated upon review of the detailed description of the preferred embodiments included below when taken in conjunction with the accompanying drawings. While the insurance incentive disclosed herein can be applied to the sale, lease, re-lease, rental, or subscription of any environmentally friendly item, the example of obtaining environmentally friendly BEV/LEV/ZEV vehicles is most readily understandable and is presented in the drawings.

FIG. 1 is a block diagram illustrating a typical relationship and transaction flow between manufacturers, retailers, purchasers, insurers, and underwriters of the prior art. There is no insurance incentive to improve the environment by obtaining a BEV/LEV/ZEV vehicle in the prior art;

FIG. 2 is a block diagram illustrating an exemplary relationship between manufacturers, retailers, purchasers, insurers and underwriters according to the present insurance incentive invention with premiums calculated by non-transitory processors and data/policies communicated and facilitated by mobility partners with the end result being an improvement in environmental quality due to customers obtaining a BEV/ZEV/LEV vehicle;

FIG. 3 is a flow chart of an exemplary process, performed by a manufacturer of an item, to provide an insurance incentive for the purchase or lease or re-lease, rental, or subscription of the environmentally friendly item, such as a BEV/ZEV/LEV vehicle;

FIG. 4 is a flow chart of an exemplary process, performed by a retailer of an item, to provide an insurance incentive for the purchase, lease, rental, or re-lease, rental, or subscription of the environmentally friendly item such as a BEV/ZEV/LEV vehicle;

FIG. 5 is a flow chart of an exemplary process, performed by an insurance affiliate, to provide an insurance policy corresponding to a sales incentive for the purchase or lease or re-lease, rental, or subscription of an environmentally friendly item such as a BEV/ZEV/LEV vehicle conveyed by a manufacturer or retailer to a qualified buyer/lessee/renter/subscriber;

FIG. 6 is a flow chart of an exemplary process, performed by a buyer of an item such as a BEV/ZEV/LEV vehicle, to receive an insurance policy with the purchase or lease or re-lease, rental, or subscription of the environmentally friendly item;

FIG. 7 is a block diagram representing an exemplary computer network for completing the provision of an insurance policy for an environmentally friendly item conveyed to a buyer/lessee/renter/subscriber.

FIG. 8 is a diagram showing how other incentives other than vehicle insurance can be bundled to encourage individuals, businesses or corporations to improve the environment by obtaining a BEV/ZEV/LEV vehicle.

### DETAILED DESCRIPTION OF THE INVENTION

According to various embodiments of the present invention, an improved insurance incentive program is introduced for promoting the sale, lease, re-lease, rental, or subscription of an environmentally friendly item. As used herein, the terms “sale,” “sell,” “selling,” “sold,” “buy”, “convey”, “transaction”, and “buying” refer to any of a purchase of an item, a purchase of an item with financing, a lease or re-lease of an item, or subscription of an item. The item may be a product produced by a manufacturer, or any product or service offered for sale, lease, re-lease, renter, or subscription by a retailer. Whether the item is purchased or lease or re-leased, rented, subscribed, or otherwise obtained, the purchaser, lessee, renter or subscriber shall be uniformly referred to herein as a “buyer” or “customer.”

In preferred embodiments, the item that is sold is an environmentally friendly LEV/BEV/ZEV automobile or vehicle of a particular make and model. The automobile or vehicle may be new, used, or off lease as those terms are understood by one of ordinary skill in the art.

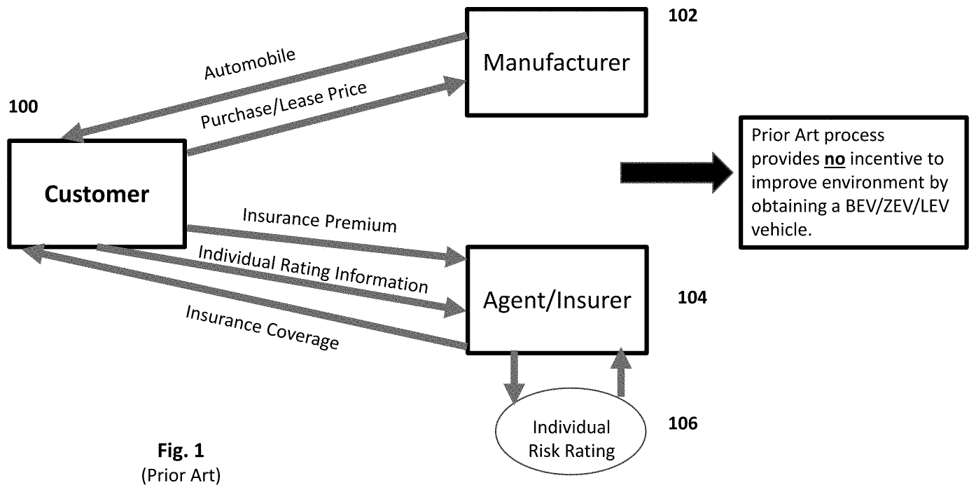

The advantages of the systems and methods of the present invention over prior programs are exemplified in FIG. 1. In typical sale, lease, re-lease, rental, or subscription of an environmentally friendly automobile, a buyer/customer 100 pays a purchase price to a manufacturer 102 for a particular make and model of an automobile offered for sale, lease, re-lease, rental, or subscription. The transaction may take place through an intermediary, such as an automobile dealer or an operator of a web site on the Internet (not shown). In consideration of most states' requirements that automobiles or vehicles have at least minimum insurance coverage prior to delivery of the automobile to the consumer, the consumer 100 must secure an insurance policy for the automobile or vehicle. This can be accomplished through an automobile dealership working in conjunction with a third party insurer 104, or the buyer may separately and independently obtain insurance coverage from an insurer 104, and provide confirmation thereof, prior to receiving the automobile. In most states, the buyer can not take possession of the vehicle until insurance documents have been received and confirmed by the OEM or dealer. Often, delays in receiving insurance documents can result in delays in the buyer taking possession of the vehicle or even cancellation of the transaction.

Given that there is not all that much experiential theft, collision, accident, etc data available to insurance companies with regard to environmentally friendly vehicles, insurers will tend to price policies high which will be a significant deterrent to consumers for obtaining the environmentally friendly vehicles.

In either event, the insurer 104 will determine an individual risk rating 106 for the buyer 100 based on certain characteristics of the buyer 100. These characteristics typically include all of the following factors: the age of the buyer 100, the sex of the buyer 100, the contemplated usage of the vehicle (business, personal, miles to be driven per day, etc.), the rating territory (broken down by city, state and/or zip code, or any portion thereof) in which the environmentally vehicle will be parked or garaged, known risk factors associated with each rating territory (i.e. rate of theft or accident within each rating territory), the driving history of the buyer 100 (i.e. the number of traffic violations and/or accidents in a preceding period of time), the number of persons of legal driving age residing with the buyer 100, and statistics relating to the model of automobile to be purchased (i.e. rate of theft and accidents involving the model).

The buyer 100 will also identify the types of insurance coverage desired for the environmentally friendly automobile. Typically, insurers offer six categories of coverage, some of which are mandatory by various state governments. These include: (1) bodily injury liability, for injuries the insured causes to another party; (2) personal injury protection (i.e. no-fault coverage), for medical expenses and lost wages relating to the treatment of injuries to the driver and passengers of the insured's automobile; (3) property damage liability, for damage caused by the insured to another's property; (4) collision coverage, for damage to the insured's car resulting from a collision with another car or object; (5) comprehensive coverage, for damage to the insured's car that doesn't involve a collision (i.e., fire, theft, falling objects, and acts of God); and (6) uninsured motorist coverage, for treatment of an insured's injuries as a result of a collision with an uninsured driver or operator.

Typically, insurance premiums may be discounted based on certain discount factors, such as a clean driving and accident record, multiple automobile coverage, automobile coverage in conjunction with other types of insurance (such as homeowners insurance), and safety factors included or added to an automobile, such as air bags, anti-theft devices, use of seat belts and the like.

From the risk factors, the selected insurance coverage and the discount factors, as well as costs and expenses borne by the insurance carrier, an individual premium is calculated by the insurer 104.

The lengthy process of obtaining insurance and the cost of the insurance itself, may be prohibitive to the buyer 100, and may influence the customer's 104 decision to obtain an environmentally friendly automobile. Furthermore, a retailer, such as an automobile dealer, may require an insurance deposit of 10-20% of the premium at the time of sale, lease, re-lease, rental, or subscription to secure an insurance policy for a predetermined period of time, for policies secured with the aid of the retailer. This increases costs to the customer 100, and again, may impact the decision to purchase the automobile. Furthermore, as noted above, since electric vehicles are fairly new to the marketplace, the fact that there is not much data on claims will result in insurers pricing their products relatively high which will provide a disincentive to obtain an environmentally friendly vehicle.

This cumbersome process presents a prospective buyer with no incentive to purchase/lease/rent/subscribe to an environmentally friendly BEV/ZEV/LEV vehicle. At best, a significant delay may be experienced in procurement of an environmentally friendly vehicle. At worst, the consumer decides not to obtain a BEV/ZEV/LEV vehicle and continues to drive a non-environmentally friendly vehicle.

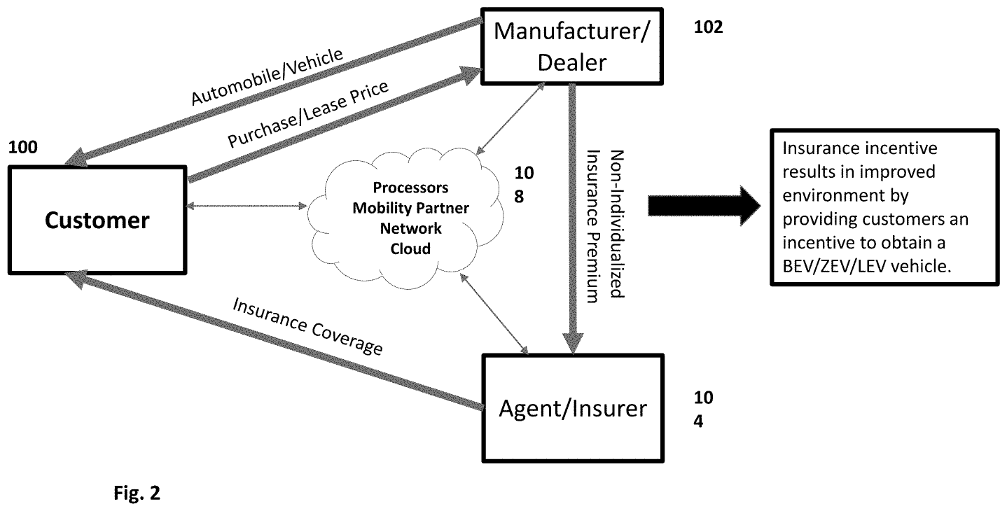

Referring now to FIGS. 2-8, wherein similar components of the present invention are referenced in like manner, preferred embodiments of an insurance incentive program for promoting the purchase or lease or re-lease, rental, or subscription of an environmentally friendly item, such as a BEV/ZEV/LEV automobile or other type of vehicle, are disclosed.

FIG. 2 schematically depicts the transactions that take place between buyer/customer 100, manufacturer 102 and insurance agent 104 according to certain embodiments for the present invention. In general, it is contemplated that a manufacturer 102, or dealers/retailers having a business relationship with the manufacturer, will select a product and promote sale, lease, re-lease, rental, or subscription, thereof through offering a transaction incentive as described herein. In particular, it is contemplated that a manufacturer of automobiles may, based on projected or current sale, lease, re-lease, rental, or subscription figures, select one or more makes and models of automobiles or vehicles that are subject to the transaction insurance incentive. In order to increase sales, leases, re-leases, rentals, or subscription of the selected makes and models, the manufacturer 102 may offer a program whereby a qualified buyer would receive a discounted or fully-paid insurance policy with the sale, lease, re-lease, rental, or subscription of the automobile. This incentive may be provided in addition to or in place of offering standard sales incentives such as rebates, lowered financing interest rates and extended warranties.

Accordingly, a transaction according to this transaction insurance incentive will resemble that depicted in FIG. 2. The buyer 100 pays a purchase price (or alternatively enters into a financing or lease or re-lease, rental, or subscription agreement) to obtain a selected automobile from the manufacturer 102, or a retailer, such as an automobile dealership having a business relationship with the manufacturer. The manufacturer 102 or retailer notifies a selected insurer 104 of the sale, lease, re-lease, rental, or subscription and secures an insurance policy on behalf of the buyer. The insurer 104 may be an affiliate of the manufacturer, as described further below. Furthermore, the insurance policy may be provided on the basis of the make and model of the automobile being purchased and the geographic area where the buyer resides, without consideration of further characteristics of the driver, also as described further below. Upon delivery of the automobile to the buyer 100, the buyer 100 receives fully paid insurance coverage from the insurer 104. The price paid by the buyer/consumer includes the cost of insurance along with other costs typically included such as taxes, registration, and, if applicable, financing costs. The transaction is facilitated by the use of various servers, non-transitory processors, networks, apps, mobility partners, the cloud, etc. 108

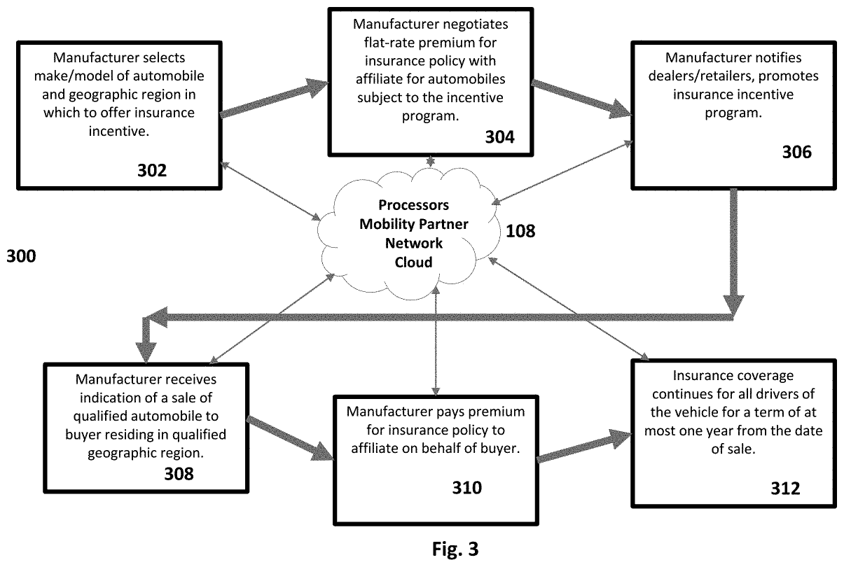

Turning now to FIG. 3, therein is depicted an exemplary process 300 for offering a transaction insurance incentive and completing a sale, lease, re-lease, rental, or subscription of an item according to one embodiment of the present invention. The process 300 begins when a manufacturer selects one or more makes and models of automobile and at least one geographic area or region in which to offer a transaction insurance incentive (step 302).

The selection of the make and model of automobile may be made based upon several factors. Since maintaining a surplus inventory is costly to both manufacturers and retailers, it is contemplated that those makes and models of automobile for which sales, leases, rentals , or subscriptions are under-performing may be selected for the sales incentive. Alternatively, or in addition, it is contemplated that those makes and models for which a new model year is approaching may be a candidate for the sales incentive program. Other factors in making the selection may be based on competition in the marketplace, i.e. trying to gain an advantage on a competing make and model of car from another manufacturer. Additional factors in making the selection of an automobile may be used.

The selection of a geographic area or region may also be made based on several business factors. One such factor is lower sales of the make and model in a particular geographic region, such as a state, a county, a city, town or village, a zip code, or any portion thereof. Another factor may be based on demographic and other statistics relating to a particular geographic region. For example, a particular geographic region may be disqualified from the program based on the rate of car theft, accidents or vandalism in the area. Other factors may also be included in the selection of geographic areas in which the sales incentive is to be offered.

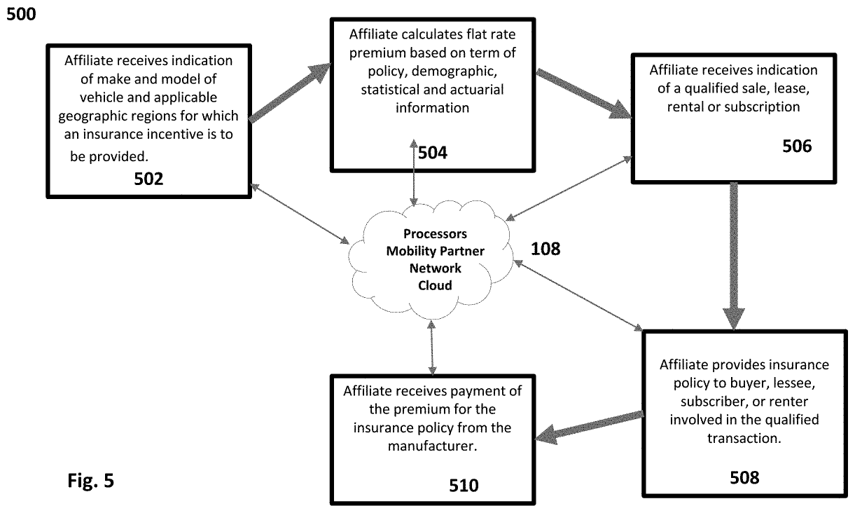

Continuing with process 300, the manufacturer 102 next negotiates the terms of insurance to be provided according to the sales/transaction incentive with the insurer 104 (step 304). In a preferred embodiment, the insurer 104 is an affiliated company related to the manufacturer 102. However, the insurer 104 may be an insurance carrier or agent. It is preferable that the types of insurance coverage, such as personal and bodily injury, liability, property damage, comprehensive, collision and uninsured motorist coverage all be provided to a buyer under the program. However, any useful subset of these coverages may be agreed upon. It is also preferable that the manufacturer be charged a flat rate for each policy initiated under the sales incentive so that costs of the incentive to the manufacturer may be more easily predicted and so that buyers may be more readily qualified without regard to individual characteristics. The determination of the flat rate for the insurance premium is discussed in more detail below with respect to FIG. 5.

Next, at step 306, the manufacturer 102 may notify retailers of the selected make and model in the selected geographic area(s) which qualify for the transaction incentive program. The manufacturer 102 may further initiate television, radio and/or print advertising notifying the public as to the sales incentive.

After the transaction incentive has been initiated, the manufacturer may next receive an indication of a sale, lease, re-lease, rental, or subscription of a qualified vehicle to a qualified buyer (step 308). The manufacturer may then pay an insurance premium on behalf of the buyer according to the transaction insurance incentive program (step 310). The insurance preferably becomes effective at the time of sale, lease, re-lease, rental, or subscription of the automobile or the time of delivery/conveyance of the vehicle to the buyer (step 312). The insurance policy preferably covers all drivers or operators of the vehicle for a period of one year from the date of sale, lease or re-lease or delivery, although any term of insurance may be provided. The process 300 then ends. The transaction is facilitated by the use of various servers, non-transitory processors, networks, apps, mobility partners, the cloud, etc. 108.

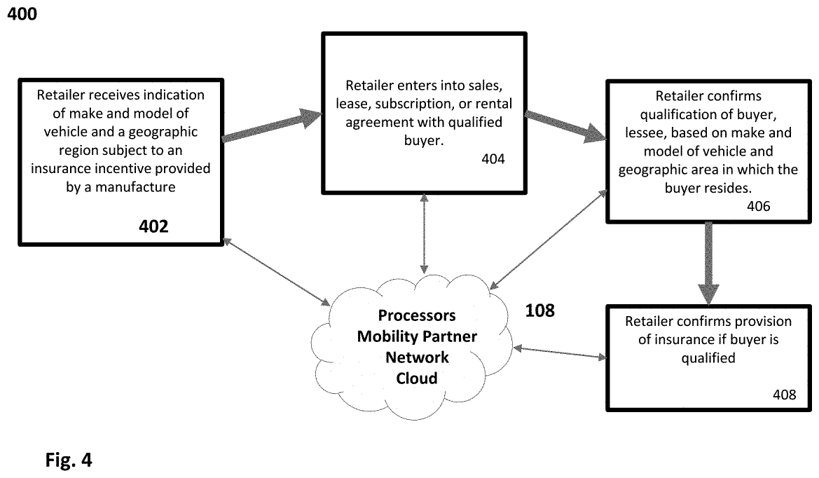

Turning now to FIG. 4, therein is depicted a process 400 by which a retailer may complete a sale, lease, re-lease, rental, or subscription of a qualified make and model of automobile or vehicle to a qualified buyer. The process 400 begins when the retailer receives an indication of qualified makes and models and qualified geographic regions according to the sales incentive program, as determined by the manufacturer 102 (step 402). The retailer may be provided with all the forms, manuals and guidelines required to successfully complete a sale, lease, re-lease, rental, or subscription according to the program.

Next, the retailer may enter into a sale, lease, re-lease, rental, or subscription transaction with a qualified buyer for a qualified automobile (step 404). The transaction may be embodied in one or more forms comprising a sales agreement for the lease, re-lease, purchase, rental, or subscription of a vehicle in which the terms of the sale, lease, re-lease, rental, or subscription are incorporated. During the sale or lease or re-lease, the retailer may confirm that the buyer lives in the required geographic region by reviewing the buyer's current driver's license or other proof of address, such as a credit report (step 406). The retailer then provides the confirmation to the manufacturer and confirms the provision of a discounted or fully-paid insurance policy to the buyer (step 408), after which process 400 ends. The transaction is facilitated by the use of various servers, non-transitory processors, networks, apps, mobility partners, the cloud, etc. 108

Referring now to FIG. 5, therein is depicted an exemplary process 500 performed by an insurer 104 for determining and providing an insurance policy according to the sales/transaction incentive program described above. As stated above, it is preferred, though not required, that the insurer 104 providing insurance coverage according to the transaction incentive program be an affiliate of the manufacturer 102. This relationship has the advantage of providing an amicable business relationship while satisfying many state requirements that prohibit a licensed entity from dispensing free insurance, since the premium will be paid to the insurer 104 by the manufacturer.

The process 500 begins when the insurer 104 receives an indication of one or more makes and models of automobile and one or more geographic areas in which the manufacturer 102 will provide the above-described transaction incentive (step 502). Based on this information, the insurer 104 preferably calculates a flat rate for each insurance policy to be issued in each geographic region (step 504).

The provision of a flat-rate insurance policy represents a divergence from standard insurance practices, in which premiums are typically calculated based on individual characteristics of the buyer, as described above. However, it is contemplated that use of regional demographic, statistical and actuarial information may be used to calculate a flat rate premium without consideration of further individual statistics such as age, sex, marital status, vehicle usage and driver history. For example, the insurer 104 may rely on average statistics for a geographical region relating to occurrences of automobile accidents, theft, vandalism and other losses for each identified make an model of automobile, or similar automobiles in the region in order to calculate a flat-rate premium.

The insurer 104 may further use average premium information as compiled by the National Association of Insurance Commissioners to determine an acceptable flat-rate premium. The insurer 104 may further account for the number of projected insurance policies that may be issued under the program, the type of coverages to be initiated under the policy, the demographics of expected buyers of the make and model of automobiles subject to the program, expected or actual costs and expenses relating to the program and the term of the policy to calculate the premium. Other known actuarial and statistical information and techniques may readily be employed as well as sophisticated statistical analyses including artificial intelligence.

Next, after the premium rates have been successfully negotiated and the program has been implemented, the insurer 104 may receive an indication of a qualified sale, lease, re-lease, rental, or subscription under the program (step 508). The insurer 104 may then provide an insurance policy to the buyer at the time of sale, lease or re-lease or delivery of the vehicle (step 510), after which, the insurer 104 receives a payment of the premium from, for example, the manufacturer 102 or the retailer on behalf of the buyer (step 512). The process 500 then ends. The transaction, delivery of the insurance policy and payment of premiums in real time is facilitated by the use of various servers, non-transitory processors, networks, apps, mobility partners, the cloud, etc. 108

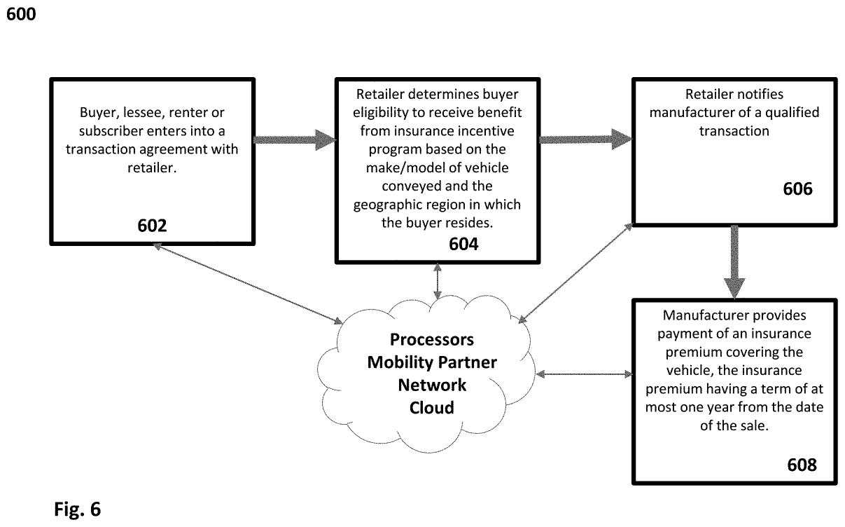

Turning now to FIG. 6, therein is depicted a process 600 by which a qualified consumer 100 receives an insurance policy with a sale, lease, re-lease, rental, or subscription of a qualified BEV/ZEV/LEV vehicle according to the transaction insurance incentive program described above. The process 600 begins at step 602 where the customer enters into a sale, lease, re-lease, rental, or subscription agreement with a retailer conveying the qualified vehicle. It is further contemplated that the sale, lease, re-lease, rental, or subscription may be made by the manufacturer 102 directly. The retailer determines the eligibility of the buyer 100 to receive insurance under the transaction insurance incentive program based on the type of BEV/ZEV/LEV vehicle to be conveyed and the geographic region in which the buyer resides (step 604) and notifies the manufacturer 102 of the qualified sale, lease, re-lease, rental, or subscription(step 606). The manufacturer 102 then provides a payment of at least a portion of the insurance premium to the insurer 104 on behalf of the buyer 100 (step 608), thereby giving the buyer a discounted or fully-paid insurance policy covering the BEV/ZEV/LEV vehicle against certain types of losses. The process 600 then ends. The transaction, delivery of the insurance policy and payment of premiums in real time is facilitated by the use of various servers, non-transitory processors, networks, apps, mobility partners, the cloud, etc. 108

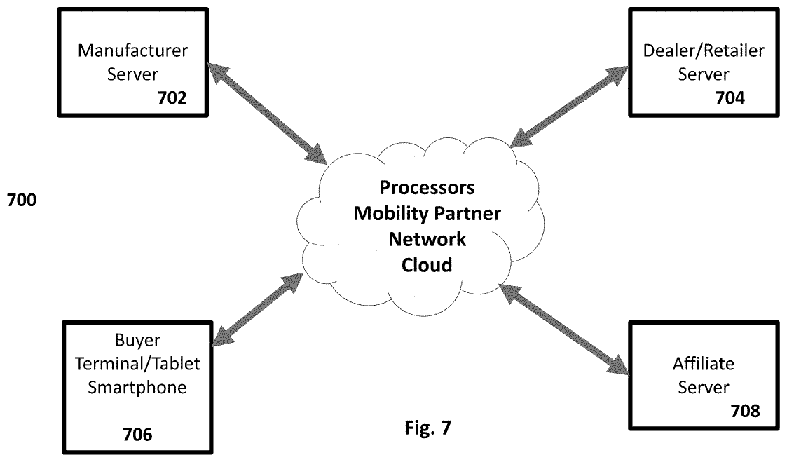

Turning to FIG. 7, it is contemplated that all the transactions described above may be implemented on a computer network 700 or series of such networks, such as the Internet, the World Wide Web, a Wide Area Network, or a Local Area Network. Such networks would of necessity include multiple layers of cybersecurity, and hyperauthentication. In such an embodiment, the manufacturer 102 may have one or more secure computer servers 702 in the network 700 for providing information on available makes and models of automobiles, completing direct sale, lease, re-lease, rental, or subscription of such automobiles and completing such transactions in accordance with the sales/transaction insurance incentive program described above. It is contemplated that one or more retailers may further have similar servers 704 in the network 700 for accomplishing the same, in addition to, or in lieu of, manufacturer servers 702.

The transaction and delivery of the insurance policy in real time is facilitated by the use of various servers, non-transitory processors, networks, apps, mobility partners, the cloud, etc. 108

The insurer 104 may operate an insurance affiliate server 708 for performing the steps described above with respect to FIG. 5. The affiliate server 708 may further handle insurance transactions directly with a buyer 100, such as processing claims, providing terms of insurance or handling buyer/consumer inquiries.

The buyer 100 may communicate with the manufacturer server 702, the dealer server 704 and/or the affiliate server 708 using a buyer terminal 706 to complete a purchase of the automobile, receive the benefit of the sales incentive program and communicate above-described insurance transactions.

Each of the servers 702, 704, 706 may be operative to communicate over the network 700 in any manner known in the art and are preferably operative to handle high-bandwidth communications from multiple buyers 100 simultaneously. The buyer terminal 706 may be any personal communications device operative to communicate over network 700, such as a personal computer with the ability to handle network communications, as well as, personal workstations, network terminals, personal digital assistants (PDAs), smart phones, tablets, cellular telephone equipped with wireless internet access or any other similar hard-wired or wireless communications equipment. Manufacturers, retailers, insurers, and affiliates may develop smart phone/tablet applications (apps) to facilitate any such BEV/ZEV/LEV vehicle transactions. Consumers may be able to consummate any such BEV/ZEV/LEV vehicle transactions without ever personally appearing at a retailer or manufacturer site. In such instances, a BEV/ZEV/LEV vehicle may be personally delivered to an individual and an insurance policy conforming to state/local requirements and standards will be sent to the individual's smart phone/tablet. By making the obtaining of BEV/ZEV/LEV vehicles and insurance easy, the environment will be improved by replacing standard internal combustion vehicles with BEV/ZEV/LEV vehicles.

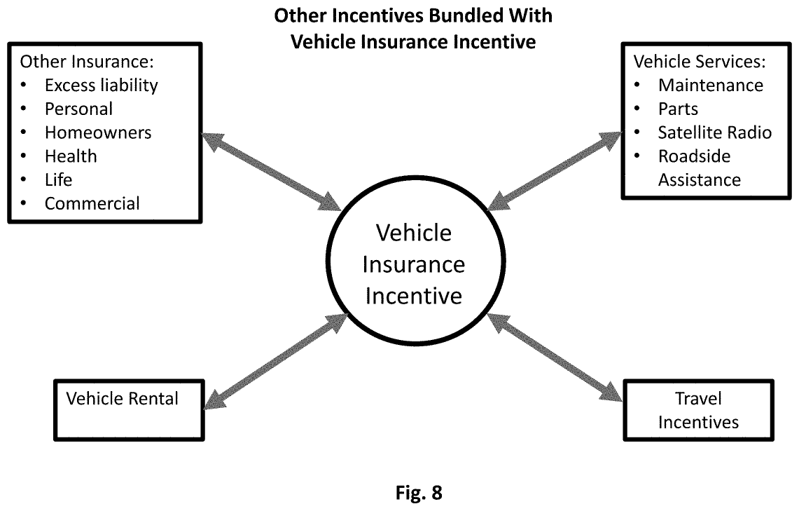

Finally, referring to FIG. 8, additional bundled incentives may be used to further incentivize the buyer to obtain a BEV/LEV/ZEV vehicle.

In addition to the above features, there are several additional embodiments contemplated to be within the scope of the present invention. For example, it is contemplated that the provision of the insurance policy under the transaction incentive program may be discounted or free to the buyer 100. However, if the buyer incurs substantial losses relating to the automobile within a particular period of time, it is contemplated that an additional charge may be levied upon the buyer 100 in order to continue the insurance coverage. It is further contemplated that the term of the provided insurance may be at most one year from the date of sale, lease, re-lease or delivery of the vehicle. However, other policy terms may likewise be used. The essence of the present invention is to improve the environment by providing a transaction insurance incentive to obtain a BEV/ZEV/LEV vehicle.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A method for improving the environment by providing a vehicle transaction insurance incentive to obtain an environmentally friendly Zero Emission Vehicles (ZEV), Low Emission Vehicles (LEV) and Battery Electric Vehicles (BEV), comprising:
receiving an indication of a sale, lease, re-lease, rental, or subscription of a BEV/LEV/ZEV vehicle;
verifying the sale, lease, re-lease, rental, or subscription of the BEV/LEV/ZEV vehicle is eligible for the insurance incentive provided by a third party;
determining via a non-transitory processor a non-individualized insurance premium for the insurance incentive associated with the vehicle based at least in part on non-individualized geographic data; and
facilitating payment of the determined non-individualized insurance premium by the third party to an insurance provider.

2. The method of claim 1, wherein the insurance incentive provides a personal insurance policy.

3. The method of claim 1, wherein the insurance incentive provides personal liability insurance coverage.

4. The method of claim 1, wherein the insurance incentive provides vehicle collision insurance coverage.

5. The method of claim 1, wherein the insurance incentive provides comprehensive insurance coverage or extra liability insurance.

6. The method of claim 1, wherein verifying the sale, lease, re-lease, rental, or subscription of the BEV/LEV/ZEV vehicle is eligible for an insurance incentive comprises verifying a make and model of the vehicle is eligible for the insurance incentive.

7. The method of claim 1, wherein verifying that the sale, lease, or subscription of the BEV/LEV/ZEV vehicle is eligible for an insurance incentive comprises verifying a geographic area associated with the sale, lease, or subscription of the BEV/LEV/ZEV vehicle is eligible for the insurance incentive.

8. The method of claim 1, wherein the third party is a BEV/LEV/ZEV vehicle manufacturer.

9. The method of claim 1 wherein the non-individualized insurance premium is determined by an affiliate.

10. The method of claim 1, wherein determining via a non-transitory processor a non-individualized insurance premium for the insurance incentive associated with the vehicle based at least in part on non-individualized geographic data occurs prior to the sale, lease, or subscription of the vehicle.

11. The method of claim 1, wherein the non-individualized insurance premium is a flat-rate insurance premium per state.

12. The method of claim 1, wherein the non-individualized geographic data comprises at least one of traffic history associated within a geographic area, average income level associated with the geographic area, and demographic information associated with the geographic area.

13. The method of claim 1, wherein determining via a non-transitory processor a non-individualized insurance premium for the insurance incentive associated with the vehicle based at least in part on non-individualized geographic data and use of actuarial data and analysis.

14. An environmentally friendly vehicle insurance incentive providing non-transitory processor-readable medium storing processor-issuable instructions to:
receive an indication of a sale, lease, rental or subscription of a BEV/LEV/ZEV vehicle;
verify the sale, lease, rental or subscription of the BEV/LEV/ZEV vehicle is eligible for an insurance incentive provided by a third party;
determine a non-individualized insurance premium for the insurance incentive associated with the BEV/LEV/ZEV vehicle based at least in part on non-individualized geographic data; and
facilitate payment of the determined non-individualized insurance premium by the third party to an insurance provider.

15. The method of claim 14 where the instructions and data transmittal are performed by non-transitory processors, smart phones, tablets, and servers over secure networks.

16. A vehicle incentive providing apparatus, comprising:
a memory;
a non-transitory processor disposed in communication with said memory, and configured to issue a plurality of processing instructions stored in the memory, wherein the processor issues instructions to:
receive an indication of a sale, lease, rental or subscription of an environmentally friendly BEV/LEV/ZEV vehicle;
verify the sale, lease, rental or subscription of the BEV/LEV/ZEV vehicle is eligible for an insurance incentive provided by a third party;
determine a non-individualized insurance premium for the insurance incentive associated with the BEV/LEV/ZEV vehicle based at least in part on non-individualized geographic data; and
facilitate payment of the determined non-individualized insurance premium by the third party to an insurance provider over secure networks.

17. The apparatus of claim 16 where the instructions and data transmittal are performed by non-transitory processors, smart phones, tablets, and servers over secure networks.

18. A method for improving the environment by bundling an insurance incentive program for the sale, lease, rental or subscription of environmentally friendly BEV/ZEV/LEV vehicles with other environmentally friendly programs.

19. The method of claim 18 where the other environmentally friendly program comprises charging a BEV/ZEV/LEV vehicle with green energy.

20. The method of claim 18 where the other environmentally friendly program comprises use of smart home technology to lower overall energy usage.

21. A method for determining a non-individualized insurance premium related to an insurance incentive to improve the environment by encouraging the sale, lease, rental or subscription of environmentally friendly BEV/ZEV/LEV vehicles, comprising
Access to and analysis of industry loss data;
Access to and analysis of manufacturer data; and
Access to and analysis of governmental data.

22. The method of claim 21 wherein artificial intelligence is utilized to facilitate
